(19) United States
(12) Patent Application Publication
(10) Pub. No.: US 2021/0094046 A1
(43) Pub. Date: Apr. 1, 2021

(54) Devices, systems, and methods for magnetically isolating and removing components of a fluid

(71) Applicants: Peter Griffin, Menlo Park, CA (US); John Jameson, Menlo Park, CA (US)

(72) Inventors: Peter Griffin, Menlo Park, CA (US); John Jameson, Menlo Park, CA (US)

(21) Appl. No.: 16/583,947

(22) Filed: Sep. 26, 2019

(51) Int. Cl. B03C 1/033; H01F 7/02

(52) U.S. Cl. CPC B03C 1/0332; H01F 7/02

(57) ABSTRACT

In one embodiment of the present invention, a filtration device can include a chamber; magnetic objects configured to bind or adhere to one or more components of a fluid; and, at least one magnet disposed on an outer surface of the chamber, wherein the chamber comprises an inlet through which the fluid may be introduced and an exit through which the fluid may be removed, at least one magnet is configured to produce magnetic fields within the fluid, and the magnetic objects are configured to move within the fluid in response to magnetic fields produced by at least one magnet. Related methods and systems are also disclosed.

### RELATED APPLICATIONS

This application claims the benefit of U.S. Provisional Patent Application Ser. No. 62/737,105, filed Sep. 27, 2018, and Ser. No. 62/788,966, filed Jan. 7, 2019, the contents of which are incorporated by reference herein.

### TECHNICAL FIELD

The present disclosure relates generally to devices, systems, and methods for isolating and/or removing one or more components of a fluid, and more particularly to devices, systems, and methods comprising magnetic objects which may move through a fluid in response to applications of magnetic fields and which may be configured to bind or adhere to one or more components of a fluid.

### BACKGROUND

Cancer remains one of the leading causes of death. In many cases, mortality is attributable not to the primary tumor itself, but to secondary tumors which form when cancerous cells shed from a primary tumor and spread via the circulatory system to other locations in the body. The removal of such circulating tumor cells (CTCs) from the blood of a patient may slow the progression of certain cancers. In addition, analyses performed on CTCs may be useful for diagnosing cancer, choosing an appropriate cancer therapy, and/or aiding cancer research. Thus, a need exists for devices, systems, and methods capable of isolating and/or removing CTCs from the blood of a patient.

### SUMMARY OF THE INVENTION

Embodiments may relate to devices, systems, and methods for isolating and/or removing one or more components of a fluid. Some embodiments may relate to devices, systems, and methods for isolating and/or removing tumor cells from a fluid. Other embodiments may relate to devices, systems, and methods for isolating and/or removing circulating tumor cells (CTCs) from blood from a person, then reintroducing the blood into the person.

Embodiments may comprise a chamber into which may be introduced a fluid volume comprising one or more components which are desired to be isolated and/or removed, magnetic objects configured to bind or adhere to the one or more components of a fluid desired to be isolated and/or removed, and one or more magnets configured to apply magnetic fields to a fluid volume within a chamber.

According to embodiments, magnetic objects configured to bind or adhere to one or more components of a fluid may comprise paramagnetic or superparamagnetic beads, particles, nanoparticles, or the like. Particular embodiments may comprise magnetic objects configured to bind or adhere to cancer cells. In very particular embodiments, magnetic objects may comprise superparamagnetic beads coated with antibodies configured to bind or adhere to CTCs.

Embodiments may comprise one or more magnets configured to apply magnetic fields to a fluid volume within a chamber. Some embodiments may comprise one or more electromagnets. Other embodiments may comprise one or more permanent magnets. Still other embodiments may comprise both one or more electromagnets and one or more permanent magnets.

According to embodiments, magnetic fields applied to a fluid volume within a chamber may vary in time and/or space. Some embodiments may comprise one or more magnets configured to produce applied magnetic fields which may vary in time and/or space in response to changes in position of one or more magnets relative to one another and/or relative to a chamber containing a fluid volume to which the one or more magnets may apply magnetic fields. Other embodiments may comprise one or more electromagnets configured to produce applied magnetic fields which may vary in time and/or space in response to an input of one or more electric currents, voltages, or powers which vary in time and/or space.

According to embodiments, magnetic objects configured to bind or adhere to one or more components of a fluid may be configured to move through, or about within, a fluid volume in response to an application of magnetic fields. In some embodiments, a movement of magnetic objects through, or about within, a fluid volume may facilitate a binding of magnetic objects to one or more components of the fluid desired to be isolated and/or removed from the fluid. In some embodiments, such magnetic field-induced “active sampling” of a fluid volume may enable magnetic objects to sample a larger portion of a fluid volume than may be feasible with other techniques, such as diffusion of magnetic objects in a relative absence of applied magnetic fields. In some embodiments, such magnetic field-induced “active sampling” of a fluid volume may reduce a time required for magnetic objects to sample a fluid volume compared to a time required by other techniques, such as diffusion of magnetic objects in an absence of applied magnetic fields.

Embodiments may be configured to cause magnetic objects to immobilize against, onto, within, or near an immobilization structure within a chamber, such as a portion of a chamber wall, in response to an application of magnetic fields. In some embodiments, applied magnetic fields used to cause magnetic objects to immobilize against, onto, within, or near one or more immobilization structures may be stronger than, or may have a different spatial and/or temporal variation than, applied magnetic fields used to cause magnetic objects to move through, or about within, a fluid volume. According to embodiments, magnetic objects may immobilize against, onto, within, or near one or more immobilization structures within a chamber in response to an application of magnetic fields even if the magnetic objects are bound or adhered to one or more components of a fluid, such as a CTC, to name but one very specific example.

In some embodiments, magnetic objects, some of which may be bound or adhered to one or more components of a fluid, may remain immobilized against, onto, within, or near an immobilization structure within a chamber, such as a chamber wall, while a fluid volume is removed from a chamber containing the fluid, leaving behind immobilized magnetic objects. Embodiments may therefore enable one or more components of a fluid to be isolated and/or removed from a fluid. This may be useful, for example, when the fluid is human blood and it is desired to reintroduce the blood into a patient without introducing magnetic objects. An immobilization of magnetic particles within a chamber may also be advantageous for preventing magnetic objects from moving while some other action takes place, such as an introduction of additional magnetic objects, an introduction of a fluid volume, or a measurement of a physical property of magnetic objects and/or a fluid component bound or adhered to them, to name but a few other actions. According to some embodiments, measurements of physical properties of magnetic objects and/or a fluid component bound or adhered to them may comprise measurements of electrical or optical characteristics. In particular embodiments, such measurements may comprise quantifying circulating tumor cells which may have been bound or adhered to magnetic objects.

Embodiments of systems may comprise components configured to control a fluid, such as tubes, valves, pumps, and the like. Embodiments may comprise components, such as electronics, computers, actuators, relays, and motors, which are configured to control the operation of other components. Embodiments may comprise components configured to analyze a fluid and/or the magnetic objects, such as optical and/or electrical analytical equipment. Embodiments may be configured to utilize a standard or modified blood dialysis machine for controlling the movement of a fluid, such as blood.

In embodiments, uses of the present devices, systems, and methods may include medical applications. Some embodiments may be useful for medical applications in which it is desirable to quickly isolate and/or remove a component of a bodily fluid, such as circulating tumor cells in blood. Particular embodiments may be well suited for medical applications in which it is desirable to remove one or more components of a fluid from a fluid volume which is large, such as substantially the entire volume of blood within an animal such as a dog, horse, or human. Very particular methods of use of the present devices may comprise an isolation and/or removal of circulating tumor cells from substantially all of the blood of a human patient.

### BRIEF DESCRIPTION OF THE DRAWINGS

FIG. 1A-FIG. 1G illustrates a filtration device in accordance with embodiments of the present invention, wherein FIG. 1A illustrates a cross-sectional view, FIG. 1B illustrates a superparamagnetic bead with antibodies, FIG. 1C illustrates a superparamagnetic bead bound with antibodies adhered to a circulating tumor cell, and FIG. 1D-FIG. 1G illustrate operation of the filtration device.

FIG. 2A-FIG. 2C illustrates operation of a filtration device in accordance with embodiments of the present invention, wherein FIG. 2A illustrates magnetic objects traversing a chamber containing a fluid volume in response to an application of magnetic fields, FIG. 2B illustrates magnetic objects traversing a chamber containing a fluid volume in the opposite direction in response to an application of magnetic fields of opposite sign, and FIG. 2C illustrates magnetic fields whose sign varies with time.

FIG. 3A-FIG. 3E illustrates immobilization structures in accordance with various embodiments of the invention, wherein FIG. 3A-FIG. 3C illustrate magnetic objects with adhered fluid components immobilized against an immobilization structures while fluid is removed from a chamber and FIG. 3D-FIG. 3E illustrate different immobilization structures.

FIG. 4A-FIG. 4B illustrates cross-sectional views of filtration chambers in accordance with different embodiments of the present invention, wherein FIG. 4A illustrates a cross-sectional view of two chambers in parallel and FIG. 4B illustrates a cross-sectional view of two chambers in series.

FIG. 5A-FIG. 5D illustrates tube-like filtration chambers in accordance with different embodiments of the present invention, wherein FIG. 5A, FIG. 5B and FIG. 5D illustrate cross-sectional views and FIG. 5C illustrates a top view.

FIG. 6A-FIG. 6L illustrates magnetic fields which may be applied to a fluid in a chamber in accordance with different embodiments of the present invention, where FIG. 6A-FIG. 6H illustrate time dependencies of the magnetic fields and FIG. 6I-FIG. 6L illustrate spatial dependencies.

FIG. 7A-FIG. 7D illustrates the movement of one or more magnets to produce variations in time and/or space of magnetic fields applied to one or more chambers.

Corresponding numerals and symbols in the different figures generally refer to corresponding parts unless otherwise indicated. The figures are drawn to illustrate relevant aspects of the embodiments and are not necessarily drawn to scale.

FIG. 8A-FIG. 8F shows an exemplary flowchart of the process cycles used to sample fluid volumes, according to the teachings of the present invention.

### DETAILED DESCRIPTION OF ILLUSTRATIVE EMBODIMENTS

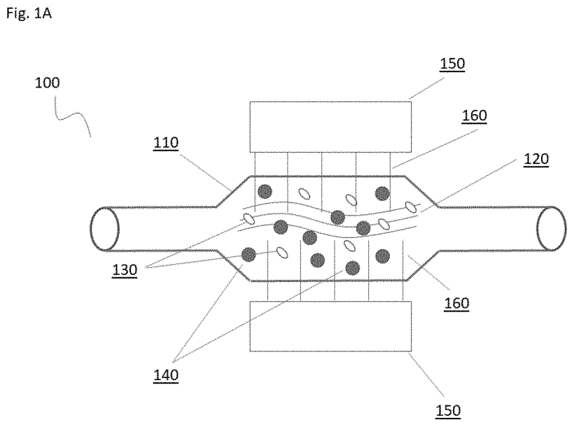

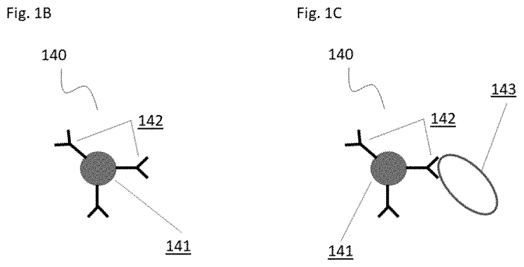

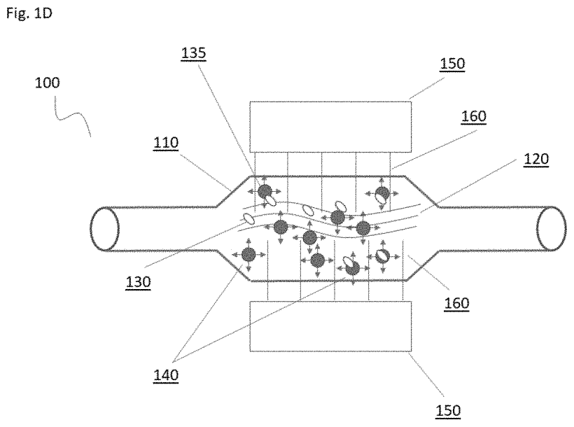

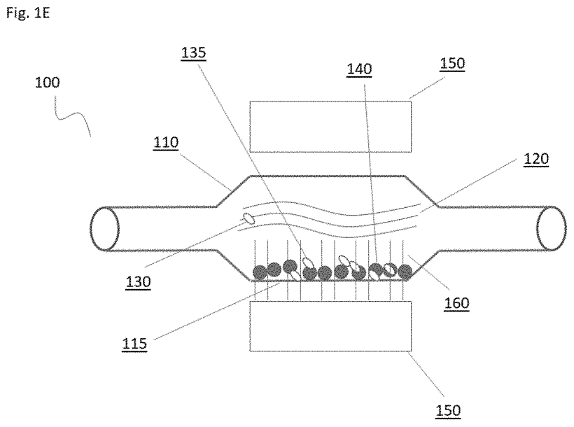

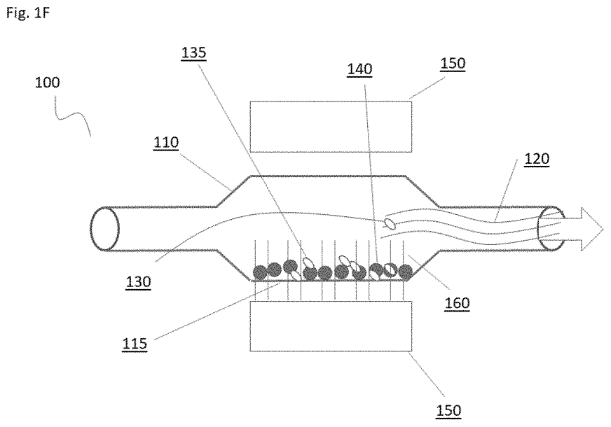

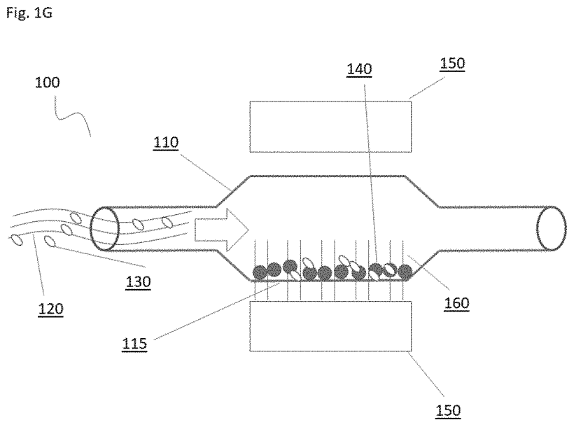

Referring to FIG. 1A, embodiments may relate to a filtration device 100 comprising a chamber 110 into which may be introduced a fluid volume 120 comprising one or more components 130 which are desired to be isolated and/or removed, magnetic objects 140 configured to bind or adhere to the one or more components 130 of a fluid, and one or more magnets 150 configured to apply magnetic fields 160 to a fluid volume 120 within a chamber 110.

According to embodiments, magnetic objects configured to bind or adhere to one or more components of a fluid may comprise paramagnetic or superparamagnetic beads, particles, nanoparticles, or the like. Particular embodiments may comprise magnetic objects configured to bind or adhere to cancer cells. Referring to FIG. 1B, in very particular embodiments, magnetic objects 140 may comprise superparamagnetic beads 141 coated with antibodies 142. Referring to FIG. 1C, embodiments may comprise magnetic objects 140 configured to bind or adhere to circulating tumor cells (CTCs) 143.

Referring again to FIG. 1A, embodiments may comprise one or more magnets 150 configured to apply magnetic fields 160 to a fluid volume 120 within a chamber 110. In some embodiments, one or more magnets 150 may be an electromagnet. In other embodiments, one or more magnets 150 may be a permanent magnet. Still other embodiments may comprise both electromagnets and permanent magnets. According to embodiments, magnetic fields applied to a fluid volume within a chamber may vary in time and/or space. Some embodiments may comprise one or more magnets configured to produce applied magnetic fields which may vary in time and/or space in response to changes in position of one or more magnets relative to one another and/or relative to a chamber containing a fluid volume to which the one or more magnets may apply magnetic fields. Other embodiments may comprise one or more electromagnets configured to produce applied magnetic fields which may vary in time and/or space in response to an input of one or more electric currents, voltages, or powers which vary in time and/or space.

Referring now to FIG. 1D, according to embodiments, magnetic objects 140 configured to bind or adhere to one or more components 130 of a fluid may be configured to move through, or about within, a fluid volume in response to an application of magnetic fields 160. In some embodiments, a movement of magnetic objects 140 through, or about within, a fluid volume 120 may facilitate a binding of magnetic objects 140 to one or more components 130 of the fluid 120 desired to be isolated and/or removed from the fluid 120. In some embodiments, such magnetic field-induced “active sampling” of a fluid volume may enable magnetic objects 140 to sample a larger portion of a fluid volume 120 than may be feasible with other techniques, such as diffusion of magnetic objects in a relative absence of applied magnetic fields. In some embodiments, such magnetic field-induced “active sampling” of a fluid volume may reduce a time required for magnetic objects to sample a fluid volume compared to a time required by other techniques, such as diffusion of magnetic objects in an absence of applied magnetic fields.

Referring now to FIG. 1E, embodiments may be configured to cause magnetic objects to immobilize against, onto, within, or near an immobilization structure within a chamber, such as a portion of a chamber wall 115, in response to an application of magnetic fields. In some embodiments, applied magnetic fields 160 used to cause magnetic objects to immobilize against, onto, within, or near one or more immobilization structures 115 may be stronger than, or may have a different spatial and/or temporal variation than, applied magnetic fields used to cause magnetic objects to move through, or about within, a fluid volume. According to embodiments, magnetic objects may immobilize against, onto, within, or near one or more immobilization structures 115 within a chamber 110 in response to an application of magnetic fields 160 even if the magnetic objects are bound or adhered to 135 one or more components of a fluid, such as a CTC, to name but one very specific example.

Referring now to FIG. 1F, in some embodiments of methods, magnetic objects 140, some of which 135 may be bound or adhered to one or more components 130 of a fluid, may remain immobilized against, onto, within, or near an immobilization structure 115 within a chamber, such as a chamber wall, while a fluid volume 120 is removed from a chamber 110 containing the fluid, leaving behind immobilized magnetic objects 140. Methods may therefore enable one or more components 130 of a fluid to be isolated and/or removed from a fluid 120. This may be useful, for example, when the fluid 120 is human blood and it is desired to reintroduce the blood into a patient without introducing magnetic objects. An immobilization of magnetic particles within a chamber may also be advantageous for preventing magnetic objects from moving while some other action takes place, such as an introduction of additional magnetic objects, an introduction of a fluid volume (FIG. 1G), or a measurement of a physical property of magnetic objects and/or a fluid component bound or adhered to them, to name but a few other actions. According to some embodiments, measurements of physical properties of magnetic objects and/or a fluid component bound or adhered to them may comprise measurements of electrical or optical characteristics. In particular embodiments, such measurements may comprise quantifying circulating tumor cells which may have been bound or adhered to magnetic objects.

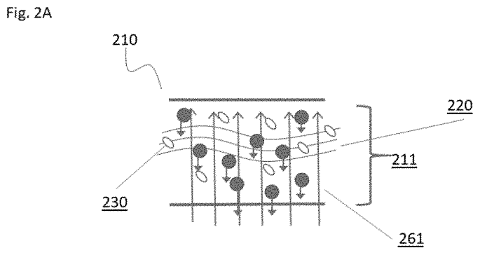

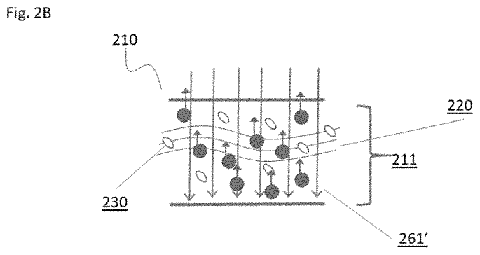

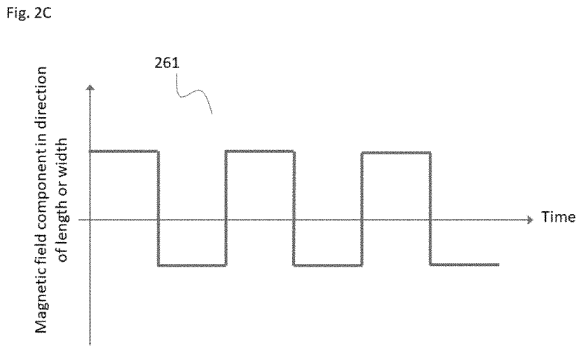

Referring now to FIG. 2A, in some embodiments, magnetic objects 230 may be caused to traverse substantially all of a length or width 211 of a chamber 210 containing a fluid volume 220 approximately once in response to an application of magnetic fields having a component 261 whose magnitude is nonzero in the direction of the length or width 211. Referring to FIG. 2B, in some embodiments, magnetic objects may be caused to traverse substantially all of a length or width of a chamber containing a fluid volume a second time in response to an application of magnetic fields having a component 261′ whose magnitude is nonzero in the direction of the length or width but whose sign is opposite that of the component of the magnetic fields which were applied to cause the magnetic particles to traverse substantially all of the length or width of the chamber a first time. In other embodiments, referring now to FIG. 2C, magnetic objects may be caused to traverse substantially all of a length or width of a chamber containing a fluid volume N times in response to applications of magnetic fields having components 261 whose magnitudes are nonzero in the direction of a length or width but whose sign alternates positive and negative with time.

Embodiments may be configured to cause magnetic objects to traverse substantially all of a length or width of a chamber containing a fluid volume approximately once in response to an application of magnetic fields. Other embodiments may be configured to cause magnetic objects to traverse substantially all of a length or width of a chamber containing a fluid volume about one to 10 times in response to an application of magnetic fields. Still other embodiments may be configured to cause magnetic objects to traverse substantially all of a length or width of a chamber containing a fluid volume about 10 to 100 times in response to an application of magnetic fields.

According to embodiments, elimination of a fluid volume from a chamber may occur in response to an elapsing of a wait time. In some embodiments, a wait time may be measured from the completion of an introduction of a fluid volume into the chamber. In other embodiments, a wait time may be measured from the completion of an introduction of magnetic objects into the chamber. In some embodiments, a wait time may be measured from the beginning of a movement of magnetic particles through, or about within, a fluid volume within the chamber in response to an application of magnetic fields. In other embodiments, a wait time may be measured from an application of a magnetic field in response to which magnetic objects immobilize against, onto, within, or near an immobilization structure within the chamber. In still other embodiments, a wait time may be measured from a removal of a magnetic field in response to which magnetic objects had been immobilized against, onto, within, or near an immobilization structure within the chamber.

According to embodiments, elimination of a fluid from a chamber may occur in response to a particular quantity of a component of the fluid adhering to magnetic objects. In some embodiments, this quantity may refer to a volume, mass, number, fraction, percentage, or other measure of a component initially present within a fluid. In particular embodiments, this quantity may refer to a volume, mass, number, fraction, percentage, or other measure of a component which is greater than about 10% of that measure initially present within a fluid. In more particular embodiments, this quantity may refer to a volume, mass, number, fraction, percentage, or other measure of a component which is greater than about 50% of that measure initially present within a fluid. In more particular embodiments, this quantity may refer to a volume, mass, number, fraction, percentage, or other measure of a component which is greater than about 90% of that measure initially present within a fluid.

In other embodiments, this quantity may refer to a volume, mass, number, fraction, percentage, or other measure relative to that measure at a previous point in time. In particular embodiments, this quantity may refer to a volume, mass, number, fraction, percentage, or other measure changing by less than about 50% relative to that measure at a previous point in time. In more particular embodiments, this quantity may refer to a volume, mass, number, fraction, percentage, or other measure changing by less than about 10% relative to that measure at a previous point in time. In even more particular embodiments, this quantity may refer to a volume, mass, number, fraction, percentage, or other measure changing by less than about 1% relative to that measure at a previous point in time.

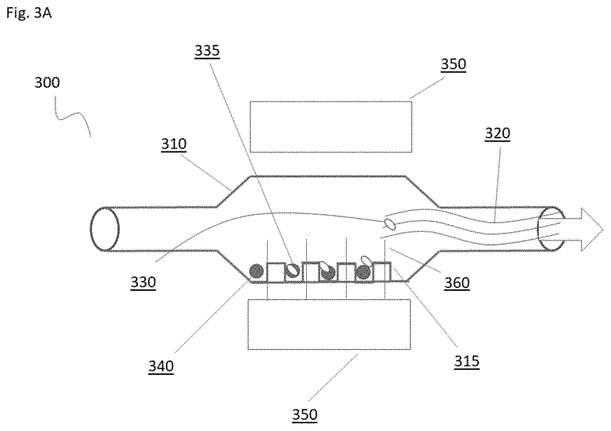

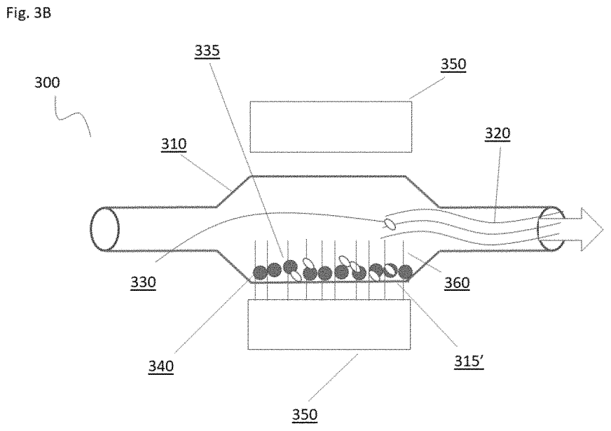

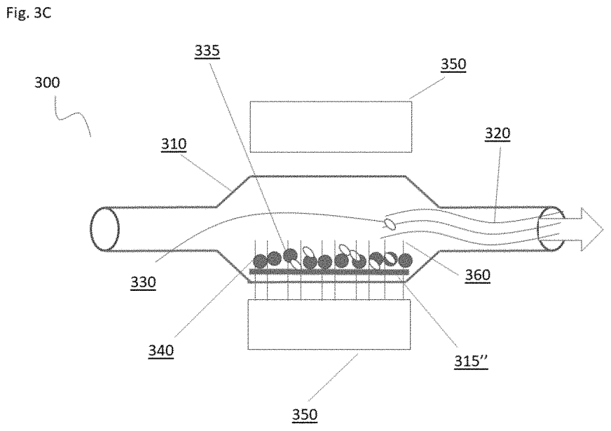

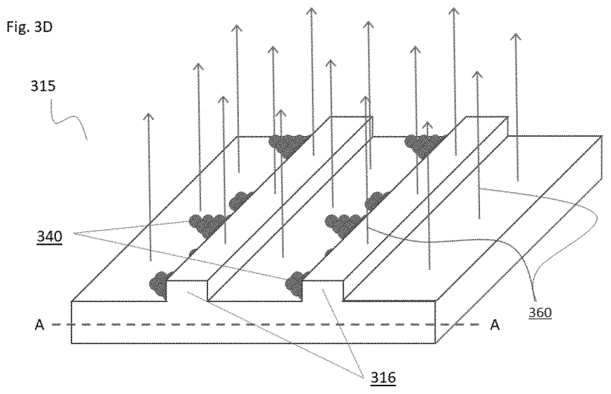

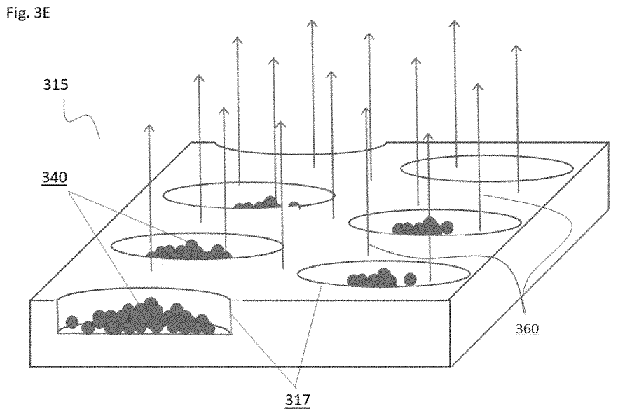

Referring to FIG. 3A, in embodiments, a filtration device 300 may comprise one or more immobilization structures 315 against which, onto which, or near which magnetic objects 340 may immobilize in response to an application of magnetic fields 360. In embodiments, magnetic objects 340 may immobilize against, onto, within, or near an immobilization structure 315 in response to an application of magnetic fields 360 even when bound or adhered to one or more components 330 of a fluid.

According to embodiments, magnetic objects may be immobilized against, onto, within, or near an immobilization structure within a chamber while a fluid volume is removed from the chamber. According to embodiments, magnetic objects may be immobilized against, or onto, or near an immobilization structure within a chamber while a fluid volume is introduced into the chamber. According to embodiments, magnetic objects may be immobilized against, or onto, or near an immobilization structure within a chamber while some other action is performed, such as an introduction of additional magnetic objects or a measurement of a physical property of the magnetic objects and/or a fluid component bound or adhered to them.

Referring to FIG. 3B, in some embodiments, an immobilization structure may comprise a portion of a chamber. In particular embodiments, an immobilization structure may comprise one or more portions 315′ of one or more chamber walls. In other embodiments, an immobilization structure may comprise one or more structures disposed within a chamber. In particular embodiments, an immobilization structure may comprise one or more structures disposed on or near an inner surface of one or more chamber walls. Referring to FIG. 3C, in very particular embodiments, an immobilization structure 315″ may comprise a sheet, film, or membrane disposed on or near an inner surface of a chamber wall.

In some embodiments, an immobilization structure may comprise a surface comprising a region which is substantially smooth. In other embodiments, an immobilization structure may comprise a surface comprising a region which is textured. In embodiments, a textured surface may be advantageous for preventing a movement of magnetic objects in response to motion of a fluid in fluid contact with the magnetic objects. In particular embodiments, a textured surface may be advantageous for reducing a probability that one or more magnetic objects may be caused to exit a chamber in response to a fluid volume being removed from the chamber.

Referring to FIG. 3D, in embodiments, a textured surface of one or more immobilization structures 315 may comprise features 316, such as channels, grooves, scratches, or the like, or combinations thereof, which are extended in one or more directions parallel to a surface of the immobilization structure 315. Referring to FIG. 3D, in some embodiments, a cross-sectional shape AA of an extended surface texture may comprise wells which are substantially square or rectangular. In other embodiments, a cross-sectional shape may be “saw tooth”, triangular, and/or combinations thereof, as but a few examples. Referring now to FIG. 3E, in other embodiments, a textured surface of one or more immobilization structures 315 may comprise features 317 which are localized, such as wells, dimples, or the like. In some embodiments, a top-down shape of a localized surface feature may be substantially round, substantially square, substantially rectangular, substantially triangular, or substantially square or rectangular with rounded corners, or combinations thereof, as but a few examples. In other embodiments, a textured surface may comprise irregular features, such pits and/or depressions whose sizes, shapes, widths, and/or depths may differ. In some embodiments, irregular features may be obtained by sand blasting or bead blasting a material surface, as but two examples.

In yet other embodiments, a textured surface of one or more immobilization structures may comprise features which are raised, such as walls or pillars, as but a few examples.

In embodiments, a method of manufacturing a textured surface of an immobilization structure may comprise an application of a subtractive process to a substantially smooth material surface, such as a chemical (wet) etch, a plasma (dry) etch, bead blasting, or sand blasting, as to name but a few examples. In other embodiments, a method of manufacturing a textured surface of an immobilization structure may comprise a molding process, such as a plastic injection molding process. In still other embodiments, a method of manufacturing a textured surface of an immobilization structure may comprise an additive process, such as chemical vapor deposition, physical vapor deposition, a sol-gel process, as to name but a few examples.

In some embodiments, magnetic fields applied to immobilize magnetic objects may be stronger than magnetic fields used to move magnetic objects through, or about within, a fluid volume. In particular embodiments, a magnetic field applied to immobilize magnetic objects may comprise a component normal to a surface of an immobilization structure which may be 10-90% stronger than corresponding normal component of a magnetic field used to move magnetic objects through, or about within, a fluid volume. In particular embodiments, a magnetic field used to immobilize magnetic objects may comprise a component normal to a surface of an immobilization structure which may be about 2-10 times stronger than a corresponding normal component of a magnetic field used to move magnetic objects through, or about within, a fluid volume. In particular embodiments, a magnetic field used to immobilize magnetic objects may comprise a component normal to a surface of an immobilization structure which may be about 10-100 times stronger than a corresponding normal component of a magnetic field used to move magnetic objects through, or about within, a fluid volume. In particular embodiments, a magnetic field used to immobilize magnetic objects may comprise a component normal to a surface of an immobilization structure which may be more than 100 times stronger than a corresponding normal component of a magnetic field used to move magnetic objects through, or about within, a fluid volume.

In some embodiments, gradients of magnetic fields applied to immobilize magnetic objects may be larger than gradients of magnetic fields used to move magnetic objects through, or about within, a fluid volume. In particular embodiments, a gradient of a magnetic field applied to immobilize magnetic objects may comprise a component normal to a surface of an immobilization structure which may be 10-90% stronger than corresponding normal component of a gradient of a magnetic field used to move magnetic objects through, or about within, a fluid volume. In particular embodiments, a gradient of a magnetic field used to immobilize magnetic objects may comprise a component normal to a surface of an immobilization structure which may be about 2-10 times stronger than a corresponding normal component of a gradient of a magnetic field used to move magnetic objects through, or about within, a fluid volume. In particular embodiments, a gradient of a magnetic field used to immobilize magnetic objects may comprise a component normal to a surface of an immobilization structure which may be about 10-100 times stronger than a corresponding normal component of a gradient of a magnetic field used to move magnetic objects through, or about within, a fluid volume. In particular embodiments, a gradient of a magnetic field used to immobilize magnetic objects may comprise a component normal to a surface of an immobilization structure which may be more than 100 times stronger than a corresponding normal component of a gradient of a magnetic field used to move magnetic objects through, or about within, a fluid volume.

In some embodiments, magnetic objects may immobilize in response to an application of magnetic fields which may vary less in time and/or space than magnetic fields applied to move magnetic objects through, or about within, a fluid volume. In particular embodiments, a magnetic field used to immobilize magnetic objects may comprise a component which may be substantially constant in time. In very particular embodiments, a magnetic field used to immobilize magnetic objects may comprise a component normal to a surface of an immobilization structure which may be substantially constant in time.

In other embodiments, magnetic objects may immobilize in response to an application of magnetic fields which may vary more in time and/or space than magnetic fields applied to move magnetic objects through, or about within, a fluid volume. In particular embodiments, magnetic objects may immobilize in response to an application of magnetic fields comprising a gradient normal to an immobilization structure which is larger than larger than the corresponding gradient of fields applied to move magnetic objects through, or about within, a fluid volume.

In some embodiments, a magnetic field used to immobilize magnetic objects may comprise a component which may be substantially constant in time and may be produced by one or more magnets disposed on a same side of a chamber. In other embodiments, magnetic fields used to immobilize magnetic objects may comprise components which may be substantially constant in time and may be produced by a plurality of magnets disposed on a plurality of sides of a chamber.

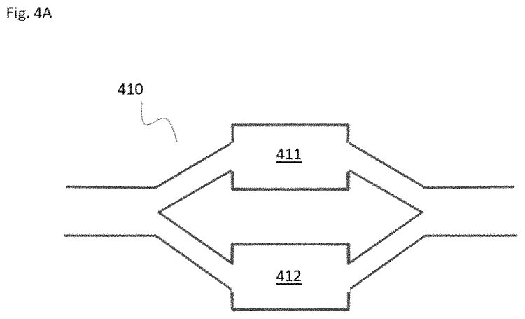

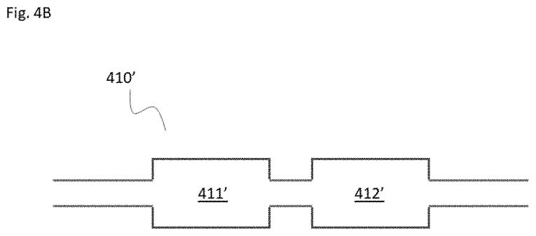

Referring now to FIG. 4A, embodiments may comprise a chamber 410 comprising a first chamber 411 connected in parallel to a second chamber 412. According to embodiments, parallel configurations may be useful for increasing a total volume of fluid which may be processed at once, or for decreasing a time required to process a total volume of fluid. Referring to FIG. 4B, other embodiments may comprise a chamber 410′ comprising a first chamber 411′ connected in series to a second chamber 412′. According to embodiments, series configurations may be useful for performing different processing steps on a fluid, such as mixing, isolation, and analysis, to name but a few. Still other embodiments may comprise a plurality of chambers connected in parallel and series.

Embodiments may comprise a chamber configured to cause magnetic objects to mix with a fluid. Embodiments may comprise a chamber configured to perform a first trapping or immobilization of magnetic objects by application of magnetic fields. Embodiments may comprise a chamber configured to perform a second or subsequent trapping or immobilization of magnetic objects by application of magnetic fields. Embodiments may comprise a chamber configured to perform a final trapping or immobilization of magnetic objects by application of magnetic fields before a fluid is removed from the device. Embodiments may comprise a chamber for dispensing magnetic objects, some of which may be bound or adhered to one or more components of a fluid.

Some embodiments may comprise a chamber configured to hold a total fluid volume about 0.1 L to 1 L. Other embodiments may comprise a chamber configured to hold a total fluid volume less than about 0.1 L. Still other embodiments may comprise a chamber configured to hold a total fluid volume greater than about 1 L.

Some embodiments may comprise a chamber comprising a cylindrical portion with a cross-section which is substantially circular, square, oval, rectangular, C-shaped, as but a few examples. Other embodiments may comprise a chamber comprising a portion having a cross-sectional shape which is irregular, such as may occur if a chamber is comprised of a flexible material.

In some embodiments, one dimension of a cross-sectional area of a chamber may be substantially larger than another dimension. Such a shape may facilitate a penetration of applied magnetic fields into, or through, a fluid volume within a chamber while still providing a desired total cross-sectional area. In particular embodiments, a first dimension of a cross-sectional area may be more than about 3 times larger than a dimension perpendicular to the first dimension. In other embodiments, a first dimension of a cross-sectional area may be more than about 5 times larger than a dimension perpendicular to the first dimension. In still other embodiments, a first dimension of a cross-sectional area may be more than about 10 times larger than a dimension perpendicular to the first dimension. In some embodiments, the direction of the larger dimension of a cross-sectional area may be a curvilinear direction, such as a direction following the perimeter of a circle, arc, or C-shape. In other embodiments, a chamber may comprise channels, such as a branching network. In particular embodiments, a fluid may comprise blood, and a chamber may comprise a network of channels configured to limit a maximum shear stress to which a fluid may be subjected during operations, such as flowing the fluid into the chamber or flowing the fluid out of the chamber. Limiting a maximum shear stress may be advantageous for minimizing certain adverse effects, such as the clotting of blood. In various embodiments, a cross-sectional shape of a chamber may vary gradually near a port. In particular embodiments, a chamber may comprise a fluid inlet port and a fluid outlet port, and a cross-sectional area of the chamber may decrease in a direction approaching an inlet port and/or an outlet port. In very particular embodiments, the fluid may comprise blood, and a chamber may be tapered so as to limit a maximum shear stress in the fluid near a port when the fluid is flowing through the port.

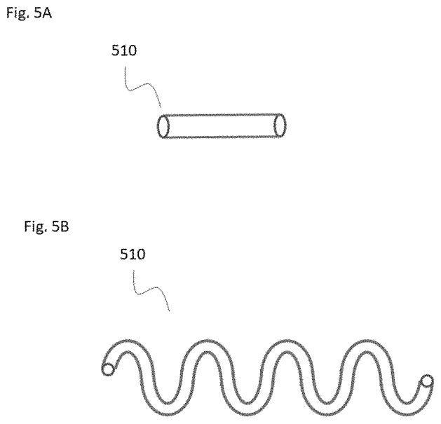

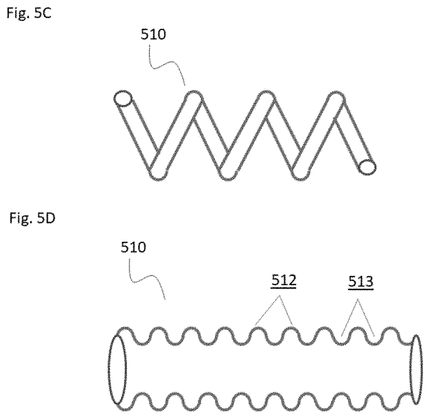

In embodiments, a chamber may comprise a tube or tubing, such as that commonly used in medical applications such as blood dialysis. Referring to FIG. 5A, in particular embodiments, a chamber 510 may comprise a length of tubing which is substantially straight. In other embodiments, a chamber 510 may comprise a length of tubing with one or more bends. Referring to FIG. 5B, in very particular embodiments, a chamber may comprise a length of tubing configured in a wavy shape. Referring to FIG. 5C, in other very particular embodiments, a chamber may comprise a length of tubing configured in a substantially helical shape. In some embodiments, a chamber may comprise a length of tubing whose diameter varies along its length. Referring to FIG. 5D, in very particular embodiments, a chamber 510 may comprise a length of tubing whose diameter varies in a substantially periodic manner along its length, having peaks 512 and valleys 513.

Various embodiments may comprise one or more chambers comprising one or more walls comprising one or more portions comprising plastic, glass, or combinations thereof. Some embodiments may comprise one or more chambers comprising one or more walls comprising one or more portions comprising injection molded plastic. In more specific embodiments, a texture of one or more wall portions may be defined during an injection molding process. In other embodiments, a texture of one or more wall portions may be defined following a plastic manufacturing process, such as by sand blasting or bead blasting. Certain embodiments may comprise one or more chambers comprising one or more walls made substantially of a same material, such as plastic, injection molded plastic, or glass, to name but a few. More specific embodiments may comprise one or more chambers comprising walls which all comprise substantially a same material, such as plastic, injection molded plastic, or glass, to name but a few.

Various embodiments may comprise chambers comprising one or more holes or ports. Embodiments may utilize one or more holes or ports to introduce a fluid into a chamber or to remove a fluid from a chamber. Embodiments may also utilize one or more holes or ports to introduce or remove magnetic objects from a chamber. Specific embodiments may comprise holes or ports configured to introduce magnetic objects into a chamber in a dispersed manner. Such configurations may comprise a plurality of holes or ports dispersed across a surface of a chamber. Embodiments may utilize one or more holes or ports to introduce or remove diagnostic or other equipment into a chamber, such as temperature sensors, flow rate sensors, chemical sensors, and/or other sensors or equipment. Embodiments may utilize one or more holes or ports to introduce magnets into or remove magnets from a chamber. Embodiments may comprise a port through which magnetic objects may be introduced into a chamber which may be a same port through which a fluid is introduced into a chamber. Other embodiments may comprise a port used to introduce a fluid which may be different from a port used to introduce magnetic objects.

Embodiments may comprise magnetic objects comprising a paramagnetic material. More specific embodiments may comprise magnetic objects comprising a superparamagnetic material. Embodiments may comprise magnetic objects comprising a diamagnetic material.

Embodiments may comprise magnetic objects comprising a polymer. Particular embodiments may comprise magnetic objects comprising polystyrene. Even more particular embodiments may comprise magnetic objects comprising superparamagnetic polystyrene beads. Even more specific embodiments may comprise magnetic objects comprising Dynabeads from Thermo-Fischer and/or MACS beads from Mittenyl.

Embodiments may comprise magnetic objects configured to bind or adhere to tumor cells, such as circulating tumor cells. Some embodiments may comprise magnetic objects comprising antibodies disposed on one or more surfaces. In specific embodiments, an antibody disposed on one or more surfaces of a magnetic object may be configured to “recognize” or bind to an antigen on a tumor cell. Other such embodiments may comprise magnetic objects comprising streptaviden disposed on one or more surfaces.

In certain embodiments, magnetic objects configured to bind or adhere to one or more components of a fluid may be larger than about 1 mm in diameter. In other embodiments, magnetic objects configured to bind or adhere to one or more components of a fluid may be smaller than about 1 mm in diameter. In still other embodiments, magnetic objects configured to bind or adhere to one or more components of a fluid may be smaller than about 10 microns in diameter. In certain embodiments, magnetic objects configured to bind or adhere to one or more components of a fluid may be about 1 micron in diameter. In very specific embodiments, magnetic objects configured to bind or adhere to one or more components of a fluid may be about 2.8 microns in diameter. In other very specific embodiments, magnetic objects configured to bind or adhere to one or more components of a fluid may be about 4.5 microns in diameter. In still other embodiments, magnetic objects configured to bind or adhere to one or more components of a fluid may be less than about 1 micron in diameter. In other embodiments, magnetic objects configured to bind or adhere to one or more components of a fluid may be about 100 nm in diameter. Embodiments may comprise magnetic objects which are substantially round, such as magnetic beads.

A magnetic field is a vector field which may possess three components at any given point in space. The components of a magnetic field may comprise components orthogonal to one another, as is familiar in a Cartesian coordinate system.

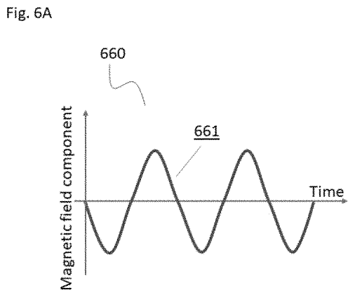

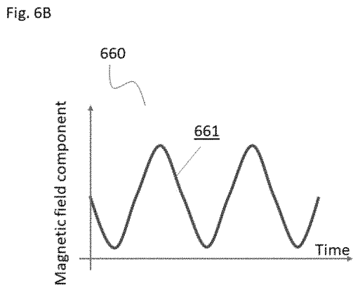

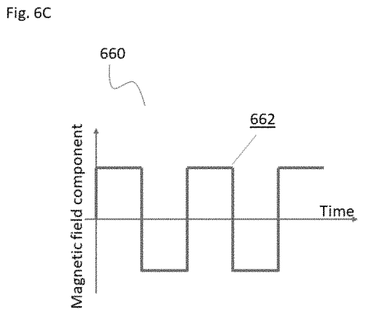

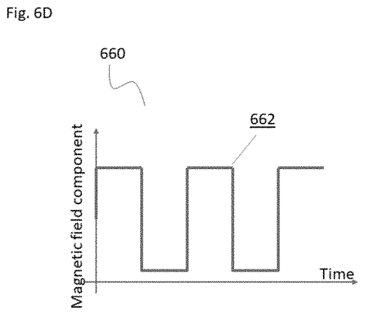

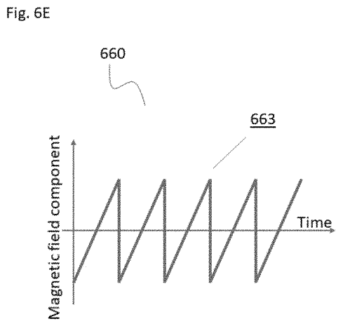

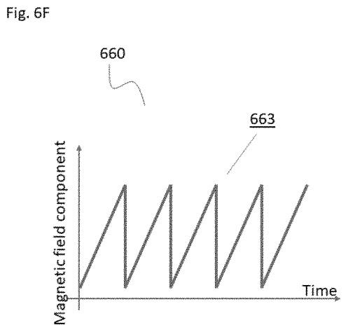

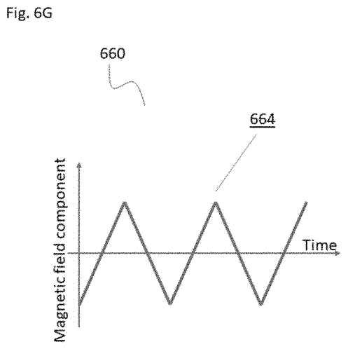

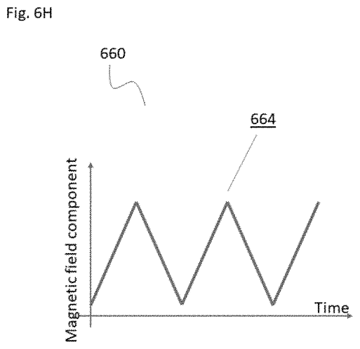

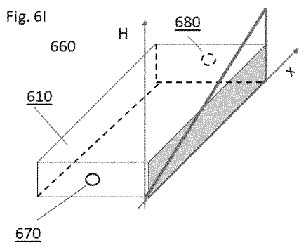

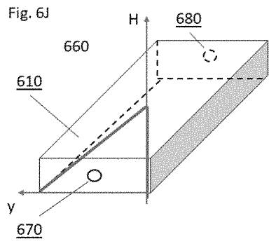

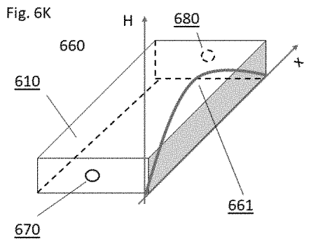

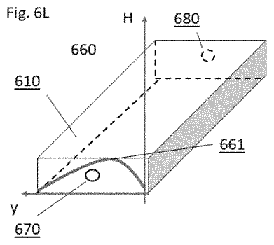

According to embodiments, a fluid within a chamber may be subjected to magnetic fields configured to have one or more spatial components which vary in time. Referring to FIG. 6A and FIG. 6B, in some embodiments, a variation in time of at least one spatial component 660 of a magnetic field may comprise an oscillating or repeating waveform 661. In some embodiments, a variation in time of at least one spatial component of a magnetic field may comprise an oscillating or repeating waveform which may comprise a sine or cosine function. In some embodiments, a variation in time of at least one spatial component of a magnetic field may comprise an oscillating or repeating waveform which may comprise a superposition of a plurality of sine and/or cosine functions. In some embodiments, a variation in time of at least one spatial component of a magnetic field may comprise an oscillating or repeating waveform which may comprise a superposition of a plurality of sine and/or cosine functions having a plurality of frequencies, wavelengths, amplitudes, and/or phases. In some embodiments, a variation in time of at least one spatial component of a magnetic field may comprise an oscillating or repeating waveform which may comprise a superposition of a plurality of sine and/or cosine functions representing components of a Fourier transform of a waveform. Referring now to FIG. 6C-FIG. 6H, according to other embodiments, a variation in time of at least one spatial component 660 of a magnetic field may comprise an oscillating or repeating waveform which may comprise a square wave 662 (FIG. 6C and FIG. 6D), a sawtooth wave 663 (FIG. 6E and FIG. 6F), a triangular wave 664 (FIG. 6G and FIG. 6H), or combinations thereof, to name but a few.

In some embodiments, a fluid may be subjected to magnetic fields configured to have one or more spatial components which may vary with position. In some embodiments, a variation with position of at least one component of a magnetic field may comprise an oscillating or repeating waveform. In some embodiments, a waveform may comprise a sine or cosine function. In particular embodiments, a waveform may comprise a superposition of such sine and/or cosine functions. In some embodiments, superposed sine and/or cosine functions may be configured to have different frequencies, wavelengths, amplitudes, and/or phases. In some embodiments, sine and/or cosine functions may be configured to represent components of a Fourier transform of a waveform. In some embodiments, sine and/or cosine functions may be configured to represent different components of a magnetic field. In other embodiments, an oscillating or repeating waveform may comprise a square wave, a sawtooth wave, a triangular wave, or combinations thereof.

In some embodiments, a variation with position of one or more spatial components of a magnetic field may not comprise an oscillating or repeating waveform. In certain embodiments, one or more components of a magnetic field may be configured to increase or decrease in magnitude in a particular spatial direction across the chamber. Referring to FIG. 6I, in other embodiments, one or more components 660 of a magnetic field may be configured to increase or decrease in magnitude as a function of a position along a direction x connecting an inlet 670 and an outlet 680 of used to input and output a fluid from a chamber 610. Referring to FIG. 6J, in other embodiments, one or more components 660 of a magnetic field may be configured to increase or decrease in magnitude as a function of position along a direction y perpendicular to a direction connecting an inlet 670 and an outlet 680 used to input and output a fluid.

In other embodiments, one or more components of a magnetic field may be configured to possess an extremum (minima or maxima) at a particular location of a chamber. Referring to FIG. 6K, in particular embodiments, one or more components 660 of a magnetic field may be configured so as to possess an extremum (maximum or minimum) 661 near a point of symmetry of a chamber, such as a midpoint between two opposing chamber walls. In other embodiments, referring to FIG. 6L, one or more components of a magnetic field may be configured so as to possess an extremum (minimum or maximum) 661 near an edge of the chamber.

According to embodiments, one or more magnets configured to apply magnetic fields to a fluid volume within a chamber may be electromagnets. According to other embodiments, one or more magnets configured to apply magnetic fields to a fluid volume within a chamber may be permanent magnets. Still other embodiments may comprise a plurality of magnets comprising both electromagnets and permanent magnets configured to apply magnetic fields to a fluid volume within a chamber.

According to other embodiments, one or more magnets configured to apply magnetic fields to a fluid volume within a chamber may be a permanent magnet with a cylindrical shape. In very specific embodiments, one or more magnets configured to apply magnetic fields to a fluid volume within a chamber may be a permanent magnet with a cylindrical shape and a magnetic polarization direction that is parallel to the axis of the cylinder (axially polarized). In other very specific embodiments, one or more magnets configured to apply magnetic fields to a fluid volume within a chamber may be a permanent magnet with a cylindrical shape and a magnetic polarization direction that is perpendicular to the axis of the cylinder (diametrically polarized). In still other very specific embodiments, one or more magnets configured to apply magnetic fields to a fluid volume within a chamber may be a permanent magnet with a cylindrical shape and a magnetic polarization direction that is not parallel or perpendicular to the axis of the cylinder.

Embodiments may comprise a magnet disposed on a side of a chamber. Some embodiments may comprise a chamber configured with a single magnet. Other embodiments may comprise a chamber configured with two or more magnets. Embodiments may comprise a plurality of magnets disposed on a same side of a chamber. Other embodiments may comprise a plurality of magnets disposed on different sides of a chamber. In particular embodiments, sides of a chamber on which magnets are disposed may be opposite sides of a chamber. In other embodiments, sides of a chamber on which magnets are disposed may be adjacent sides of a chamber. Very particular embodiments may comprise magnets and a chamber in a “parallel plate” configuration, such that substantially flat surfaces of two magnets are arranged parallel to one another and disposed on opposite sides of a chamber.

Other embodiments may comprise a cylindrical magnet and a cylindrical chamber whose axes are parallel to one another. Particular embodiments may comprise a diametrically polarized cylindrical magnet whose axis is parallel to the axis of a cylindrical chamber. Other particular embodiments may comprise a diametrically polarized cylindrical magnet whose axis is perpendicular to the axis of a cylindrical chamber. Particular embodiments may comprise an axially polarized cylindrical magnet whose axis is parallel to the axis of a cylindrical chamber. Other very particular embodiments may comprise an axially polarized cylindrical magnet whose axis is perpendicular to the axis of a cylindrical chamber.

Other embodiments may comprise a tubular chamber disposed in a direction parallel to the axis of a cylindrical magnet. Particular embodiments may comprise a tubular chamber disposed in a direction parallel to the axis of a diametrically polarized cylindrical magnet. Other particular embodiments may comprise a tubular chamber disposed in a direction perpendicular to the axis of a diametrically polarized cylindrical magnet. Particular embodiments may comprise a tubular chamber disposed in a direction parallel to the axis of an axially polarized cylindrical magnet. Other particular embodiments may comprise a tubular chamber disposed in a direction perpendicular to the axis of an axially polarized cylindrical magnet.

Another very particular embodiment may comprise a magnet with a substantially flat surface disposed on a surface of a chamber, and a plate (e.g., a plate comprising iron) arranged parallel to the flat surface of the magnet and disposed on a side of a chamber opposite that of the magnet.

Embodiments may comprise a gap between a magnet disposed on a surface of a chamber and the surface on which the magnet is disposed. Other embodiments may comprise substantially no gap between a magnet and the surface on which the magnet is disposed. Still other embodiments may comprise a material sheet disposed in a gap between a magnet and a surface on which the magnet is disposed.

Embodiments may comprise electrical means to produce variations in time and/or space of magnetic fields applied to one or more chambers. In some embodiments, electrical means may comprise variations in electrical currents supplied to one or more electromagnets. In some embodiments, electrical means may comprise variations in electrical voltages supplied to one or more electromagnets. In some embodiments, electrical means may comprise variations in electrical power supplied to one or more electromagnets.

Embodiments may comprise mechanical means to produce variations in time and/or space of magnetic fields applied to one or more chambers. In some embodiments, mechanical means may comprise movement (translation) of one or more magnets. In some embodiments, mechanical means may comprise rotation of one or more magnets. In some embodiments, mechanical means may comprise both translation and rotation of one or magnets.

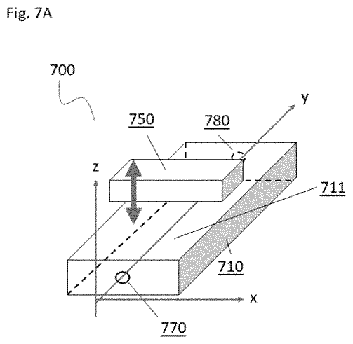

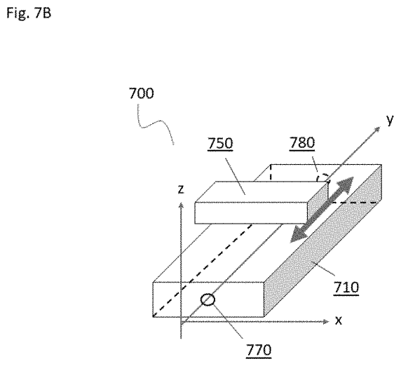

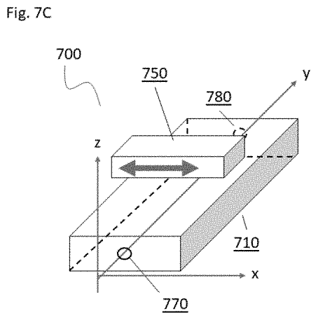

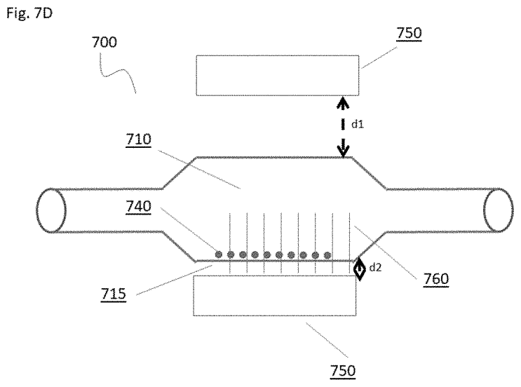

Embodiments may comprise one or more magnets which are movable (translatable). Referring to FIG. 7A, in some embodiments, a filtration device 700 may comprise one or more magnets 750 which are movable in a z-direction, where a z-direction may refer to a direction substantially normal to a wall 711 of a chamber 710. Referring to FIG. 7B, some embodiments may comprise one or more magnets which are movable in a y-direction, where a y-direction may refer to a direction substantially parallel to a length or width direction of a chamber, such as a direction connecting an inlet 770 and outlet 780 port. Referring to FIG. 7C, some embodiments may comprise one or more magnets 750 which are movable in a x-direction where a x-direction may refer to a direction substantially perpendicular to a direction y connecting an inlet 770 and an outlet 780 of chamber 710. Other embodiments may comprise one or more magnets which are movable in a combination of x-, y-, and/or z-directions.

Embodiments may comprise one or more magnets which may rotate. Some embodiments may comprise one or more magnets which may rotate about a z-direction. Some embodiments may comprise one or more magnets which may rotate about an x-direction. Some embodiments may comprise one or more magnets which may rotate about a y-direction. Some embodiments may comprise one or more magnets which may rotate about a combination of x-, y-, and/or z-directions.

Referring to FIG. 7D, in certain embodiments, magnetic objects 740 within a chamber 710 may immobilize against an interior surface of the chamber wall 715 in response to one or more magnets 750 moving closer to an exterior surface of a chamber wall 715 than one or more magnets may be (i.e., d1>d2) in order to cause magnetic objects to move through, or about within, a fluid volume within a chamber. This may be advantageous for preventing magnetic objects from moving while a fluid volume is introduced or removed from a chamber, or some other operation is performed.

Embodiments may comprise devices configured to move one or more magnets, such as springs, actuators, piezoelectric actuators, motors, and the like.

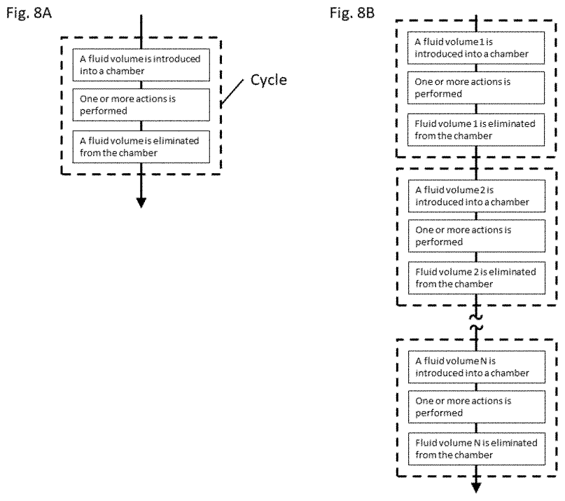

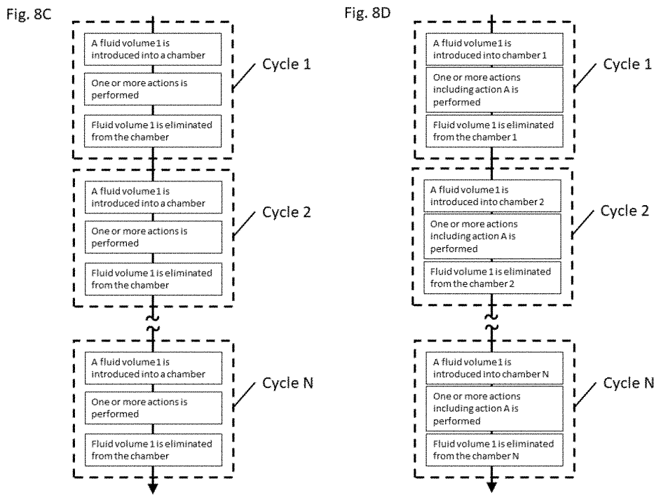

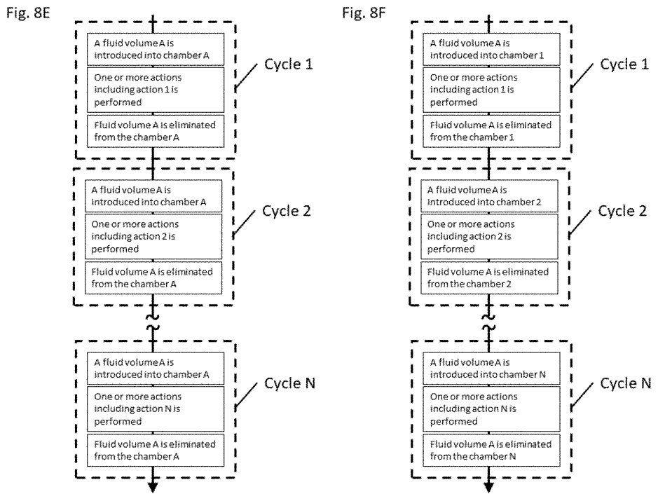

Referring now to FIG. 8A, embodiments may comprise methods comprising the steps of introducing a fluid volume into a chamber, performing one or more actions on the fluid volume within the chamber, and eliminating a fluid volume from the chamber. Such a sequence of steps may be referred to as a “cycle”.

Referring now to FIG. 8B, embodiments may comprise methods in which a same cycle is performed on a sequence of different fluid volumes. Referring now to FIG. 8C, other embodiments may comprise methods in which a same cycle is performed more than once on a same fluid volume.

Referring now to FIG. 8D, embodiments may comprise methods in which a fluid volume is subjected to a cycle comprising a particular action in a particular chamber, then subjected to a cycle comprising the same action in one or more different chambers.

Referring now to FIG. 8E, still other embodiments may comprise methods in which a fluid volume is subjected to a cycle comprising a particular action in a particular chamber, then subjected to a cycle comprising a different action in the same chamber.

Referring now to FIG. 8F, other embodiments may comprise methods in which a fluid volume is subjected to a cycle comprising a particular action in a particular chamber, then subjected to a cycle comprising a different action in a different chamber.

Embodiments may comprise a method in which a fluid volume is introduced into a chamber, one or more components of the fluid are bound or adhered to magnetic objects within the chamber, the magnetic objects are immobilized against a structure, and the remainder of the fluid eliminated from the chamber.

Embodiments may comprise a method in which a fluid volume is introduced into a chamber, magnetic objects are then introduced into the chamber, one or more components of the fluid are bound or adhered to the magnetic objects, the magnetic objects are immobilized against a structure, and the remainder of the fluid eliminated from the chamber.

Embodiments may comprise a method in which a fluid volume is introduced into a chamber, magnetic objects are then introduced into the chamber, the magnetic objects are caused to move about or within the fluid by an application of magnetic fields, the magnetic objects are immobilized against a structure by an application of magnetic fields, and the fluid volume then eliminated from the chamber.

Embodiments may comprise a method in which magnetic objects are introduced into a chamber, a fluid volume is then introduced into the chamber, the magnetic objects are caused to move about or within the fluid by an application of magnetic fields, the magnetic objects are immobilized against a structure by an application of magnetic fields, and the fluid volume then eliminated from the chamber.

In alternate embodiments, a fluid comprising one or more components desired to be isolated and/or removed may be flowed continuously through a chamber containing magnetic objects. In such embodiments, an applied magnetic field may be configured so as to cause the magnetic objects to move about within in the fluid in the chamber without being removed from the chamber by the flowing fluid. This may be accomplished in some embodiments by applying a magnetic field having one or more components that apply forces to the magnetic objects which oppose the forces applied by the moving fluid.

Embodiments may comprise methods in which magnetic objects are introduced into a chamber by introducing a “carrier” fluid comprising magnetic objects. In particular embodiments, a carrier fluid may be configured to hold magnetic objects in suspension. In some embodiments, a volume of carrier fluid comprising magnetic objects may be introduced into a chamber, magnetic objects may be immobilized against, onto, within, or near one or more immobilization structures in response to an application of magnetic fields, and carrier fluid then eliminated from the chamber, leaving behind magnetic objects immobilized against, onto, within, or near the one or more immobilization structures.

In some embodiments, a volume of a carrier fluid may be smaller than a volume of a “target” fluid comprising one or more components desired to be isolated and/or removed. In some embodiments, a volume of a carrier fluid may less than about 10% of a volume of a target fluid. In some embodiments, a volume of a carrier fluid may less than about 1% of a volume of a target fluid. In some embodiments, a volume of a carrier fluid may less than about 0.1% of a volume of a target fluid.

In other embodiments, a volume of a carrier fluid may be small compared to a volume of a chamber into which the magnetic objects are introduced. In some embodiments, a volume of a carrier fluid may less than about 10% of a volume of a chamber into which the magnetic objects are introduced. In some embodiments, a volume of a carrier fluid may less than about 1% of a volume of a chamber into which the magnetic objects are introduced. In some embodiments, a volume of a carrier fluid may less than about 0.1% of a volume of a chamber into which the magnetic objects are introduced.

In some embodiments, a volume of a carrier fluid may be about the same as a volume of a chamber into which the magnetic objects are introduced. In other embodiments, a volume of a carrier fluid may larger than a volume of a chamber into which the magnetic objects are introduced.

The above description of the invention is intended to be illustrative and should not be construed as limiting in scope or spirit. It should be understood that some illustrative embodiments described above may contain more than one inventive element. An embodiment of the invention need not incorporate all of the inventive elements of any given illustrative embodiment described above. Likewise, specific embodiments of the present invention may incorporate one or more inventive elements from more than one of the illustrative embodiments described above.

What is claimed is:

1. A fluid filtration device comprising:
a chamber;
magnetic objects configured to bind or adhere to one or more components of a fluid; and at least one magnet disposed on an outer surface of the chamber,
wherein the chamber comprises an inlet through which the fluid may be introduced and an exit through which the fluid may be removed, and
wherein at least one magnet is configured to produce magnetic fields within the fluid, and
wherein the magnetic objects are configured to move within the fluid in response to magnetic fields produced by at least one magnet.

2. The device of claim 1, wherein the chamber comprises an immobilization structure against which the magnetic objects may immobilize in response to an application of immobilization magnetic fields produced by one or more magnets.

3. The device of claim 2, wherein an immobilization magnetic field may comprise one of more spatial components whose magnitude is greater than the corresponding component of a magnetic field configured to cause the magnetic objects to move within the fluid.

4. The device of claim 2, wherein an immobilization magnetic field may comprise one of more spatial gradients whose magnitude is greater than the corresponding gradients of magnetic fields configured to cause the magnetic objects to move about within the fluid.

5. The device of claim 1, wherein the magnetic objects comprise superparamagnetic polystyrene beads.

6. The device of claim 4, where in the diameter of the superparamagnetic polystyrene beads is in the range from 1 to 10 microns.

7. The device of claim 5, wherein the superparamagnetic polystyrene beads have antibodies adhered to their surface configured to bind with cancer cells.

8. The device of claim 1, wherein the chamber is a tube.

9. The device of claim 1, wherein one or more magnets is a diametrically polarized cylindrical magnet comprising neodymium.

10. The device of claim 9, wherein whose axis is substantially parallel to a direction extending from an inlet of the chamber to an outlet of the chamber.

11. A method of operating a fluid filtration device, the method comprising:
introducing a fluid into a chamber;
introducing magnetic objects into the chamber;
moving the magnetic objects about within the fluid by a first application of magnetic fields from one or more magnets disposed on an exterior surface of the chamber;
immobilizing the magnetic objects against an interior surface of the chamber by a second application of magnetic fields from one or more magnets disposed on an exterior surface of the chamber;

12. The method of claim 11, further comprising removing fluid from a chamber through an outlet after immobilizing the magnetic object against an interior surface of the chamber; and introducing additional fluid into the chamber through an inlet.

13. The method of claim 11, wherein the magnets disposed on an exterior surface of the chamber are diametrically polarized cylindrical magnets.

14. The method of claim 11, wherein one or more spatial component of the magnetic fields of the second application of magnetic fields is larger than the corresponding component of the magnetic fields of the first application of magnetic fields.

15. The method of claim 11, wherein one or more gradients of the magnetic fields of the second application of magnetic fields is larger than the corresponding gradients of the magnetic fields of the first application of magnetic fields.
